(19) United States
(12) Patent Application Publication
(10) Pub. No.: US 2008/0186350 A1
(43) Pub. Date: Aug. 7, 2008

(54) INK JET PRINTER

(75) Inventors: Atsushi OSHIMA, Shiojiri-shi (JP); Kunio TABATA, Shiojiri-shi (JP); Toshiyuki SUZUKI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/026,129

(22) Filed: Feb. 5, 2008

(30) Foreign Application Priority Data
Feb. 7, 2007 (JP) 2007-028025

(51) Int. Cl. B41J 29/38

(52) U.S. Cl. 347/16

(57) ABSTRACT

Provided is an ink jet printer in which ink jet heads are arranged in correspondence with a print region and printing is performed with respect to the print region while transporting a print medium, the ink jet printer including: a first print medium transporting unit provided at an upstream side of a print medium transporting direction; a second print medium transporting unit provided at a downstream side of the print medium transporting direction of the first print medium transporting unit so as to continuously transport the print medium from the first print medium transporting unit; a first print medium transporting state detecting device which detects a transporting state of the print medium by the first print medium transporting unit; a second print medium transporting state detecting device which detects the transporting state of the print medium by the second print medium transporting unit; a plurality of nozzles arranged in the ink jet heads in a direction crossing the print medium transporting direction; actuators provided in correspondence with the nozzles; a first driving signal generating device which generates a first driving signal to the actuators according to the transporting state of the print medium by the first print medium transporting unit detected by the first print medium transporting state detecting device; a second driving signal generating device which generates a second driving signal to the actuators according to the transporting state of the print medium by the second print medium transporting unit detected by the second print medium transporting state detecting device; and a control device which mixes and outputs the first driving signal generated by the first driving signal generating device and the second driving signal generated by the second driving signal generating device to the plurality of nozzles arranged in the ink jet heads in the direction crossing the print medium transporting direction.

### BACKGROUND

1. Technical Field

The present invention relates to an ink jet printer which forms a predetermined character or image by discharging, for example, a plurality of tiny droplets of liquid ink having a plurality of colors from a plurality of nozzles and forming particles (ink dots) on a print medium.

2. Related Art

As personal computers or digital cameras come into wide use, ink jet printers have come into wide use by general users as well as offices, because a color printed matter can be readily obtained with low cost.

In the ink jet printer, generally, while a movable body called a carriage integrally including ink cartridges and print heads is reciprocally moved in a direction crossing a transporting direction of a print medium, droplets of liquid ink are discharged (ejected) from nozzles of the print head to form minute ink dots on the print medium and a predetermined character or image is formed on the print medium, thereby preparing a desired printed matter. Since the ink cartridges of four colors (yellow, magenta, cyan and black) and the print heads of the respective colors are included in the carriage, it is possible to readily perform full-color printing using a combination of the above-described colors as well as monochromic printing (six colors, seven colors or eight colors including light cyan or light magenta in addition to the above-described colors is practicable).

In an ink jet printer for performing printing while an ink jet head of the carriage is reciprocally moved in a direction crossing a transporting direction of a print medium, the ink jet head needs to be reciprocally moved ten times or several tens times, in order to print clearly one page. In contrast, in an ink jet printer in which an ink jet head (does not need to be integrally formed) having a length equal to the width of a print medium are mounted and a carriage is not used, the ink jet head does not need to be moved in a width direction of the print medium and thus so-called one-pass printing is possible. In the former ink jet printer is generally called a multipass (serial) ink jet printer and the latter ink jet printer is generally called a line head ink jet printer.

In such an ink jet printer, for example, a transporting belt is charged with charges, the print medium made of an insulating material is electrostatically sucked and transported by the transporting belt, and ink droplets are discharged from the ink jet head onto the transported print medium, thereby performing the printing. In addition, the print medium may be sucked and transported by the transporting belt with pneumatic negative pressure. In particular, such a method of transporting the print medium is efficient in the line head ink jet printer. In an ink jet printer disclosed in JP-A-2005-75475, line head ink jet heads are positioned at two places including an upstream side and a downstream side of the print medium transporting direction, two print medium transporting units, in which a plurality of transporting belts are provided at a predetermined interval in the direction crossing the print medium transporting direction, are arranged in the print medium transporting direction in correspondence with the ink jet heads, and ink droplets are discharged from the ink jet heads at the upstream and downstream sides onto the transported print medium, thereby performing printing. The ink jet heads are provided in a gap between the transporting belts and so-called cleaning for restoring nozzles using a cleaning unit provided immediately beneath the ink jet head is performed.

In the ink jet printer disclosed in JP-A-2005-75475, in which the print medium transporting units composed of the plurality of transporting belts are arranged in the print medium transporting direction, for example, there is provided a method of attaching an upstream encoder sensor to the transporting belt at the upstream side of the print medium transporting direction, attaching a downstream encoder sensor to the transporting belt at the downstream side of the print medium transporting direction, detecting the print medium transporting states of the print medium transporting units from the output signals from the encoder sensors, outputting driving signals to actuators of the nozzles of the ink jet heads according to the detected print medium transporting states, and discharging ink droplets from the nozzles. By this configuration, since the print medium transporting states can be directly detected by the print medium transporting unit at the upstream side of the print medium transporting direction and the print medium transporting unit at the downstream side of the print medium transporting direction, higher-quality printing is possible.

However, in such a method of discharging the ink droplets, when the print medium is transferred from the print medium transporting unit at the upstream side of the print medium transporting direction to the print medium transporting unit at the downstream side of the print medium transporting direction, if the driving signals to the actuators of the plurality of nozzles arranged in the direction crossing the print medium transporting direction according to the encoder sensor at the upstream side of the print medium transporting direction are switched to the driving signals according to the encoder sensor at the downstream side of the print medium transporting direction, image shift having a stripe shape occurs in a print image when the phases of the output signals of the encoders are shifted from each other, and thus print image quality deteriorates.

### SUMMARY

An advantage of some aspects of the invention is that it provides an ink jet printer capable of ensuring excellent print image quality by making print image shift inconspicuous when a print medium is transferred from a print medium transporting unit at an upstream side of a print medium transporting direction to a print medium transporting unit at a downstream side of the print medium transporting direction.

According to an aspect of the invention, there is provided an ink jet printer in which ink jet heads are arranged in correspondence with a print region and printing is performed with respect to the print region while transporting a print medium, the ink jet printer including: a first print medium transporting unit provided at an upstream side of a print medium transporting direction; a second print medium transporting unit provided at a downstream side of the print medium transporting direction of the first print medium transporting unit so as to continuously transport the print medium from the first print medium transporting unit; a first print medium transporting state detecting device which detects a transporting state of the print medium by the first print medium transporting unit; a second print medium transporting state detecting device which detects the transporting state of the print medium by the second print medium transporting unit; a plurality of nozzles arranged in the ink jet heads in a direction crossing the print medium transporting direction; actuators provided in correspondence with the nozzles; a first driving signal generating device which generates a first driving signal to the actuators according to the transporting state of the print medium by the first print medium transporting unit detected by the first print medium transporting state detecting device; a second driving signal generating device which generates a second driving signal to the actuators according to the transporting state of the print medium by the second print medium transporting unit detected by the second print medium transporting state detecting device; and a control device which mixes and outputs the first driving signal generated by the first driving signal generating device and the second driving signal generated by the second driving signal generating device to the plurality of nozzles arranged in the ink jet heads in the direction crossing the print medium transporting direction.

By the configuration of the invention, when the print medium is transferred from the first transporting unit at the upstream side of the print medium transporting direction to the second transporting unit at the downstream side of the print medium transporting direction, print image shift can be made inconspicuous and thus excellent print image quality can be ensured.

In the ink jet printer of the invention, the control device may be mix and output the first driving signal and the second driving signal to the plurality of nozzles arranged in the ink jet heads in the direction crossing the print medium transporting direction, even when the first driving signal and the second driving signal are switched in accordance with the transferring of the print medium from the first print medium transporting unit to the second print medium transporting unit.

By the configuration of the invention, print image shift can be made inconspicuous with certainty and thus more excellent print image quality can be ensured.

In the ink jet printer of the invention, the first print medium transporting unit and the second print medium transporting unit may be respectively composed of a first transporting belt and a second transporting belt, and the first print medium transporting state detecting device and the second print medium transporting state detecting device may be respectively composed of first and second encoder sensors which detect the transporting states of the print medium from movement states of the first transporting belt and the second transporting belt.

By the configuration of the invention, the configuration of the sensor for detecting the transporting state of the print medium becomes simplified and the invention is easy to be implemented.

### BRIEF DESCRIPTION OF THE DRAWINGS

The invention will be described with reference to the accompanying drawings, wherein like numbers reference like elements.

FIG. 1 is a schematic front view showing the configuration of an ink jet printer according to a first embodiment of the invention.

FIG. 2 is a plan view of the ink jet printer shown in FIG. 1.

FIG. 3 is a block diagram of a control device of the ink jet printer shown in FIG. 1.

FIG. 4 is a view illustrating the generation of a driving signal.

FIG. 5 is a view illustrating a driving signal obtained by connecting driving pulses in time series.

FIG. 6 is a view illustrating driving signals, latch signals, channel signals and driving signal selection data supplied to an ink jet head.

FIG. 7 is a block diagram of a selection unit for connecting driving signals to nozzle actuators.

FIG. 8 is a block diagram of nozzle actuators and selection switches.

FIG. 9 is a view showing an example of selection states of a first driving signal and a second driving signal and ink dots.

FIG. 10 is a view showing another example of the selection states of the first driving signal and the second driving signal and the ink dots.

FIG. 11 is a view showing a comparative example of the selection states of the first driving signal and the second driving signal and the ink dots.

### DESCRIPTION OF EXEMPLARY EMBODIMENTS

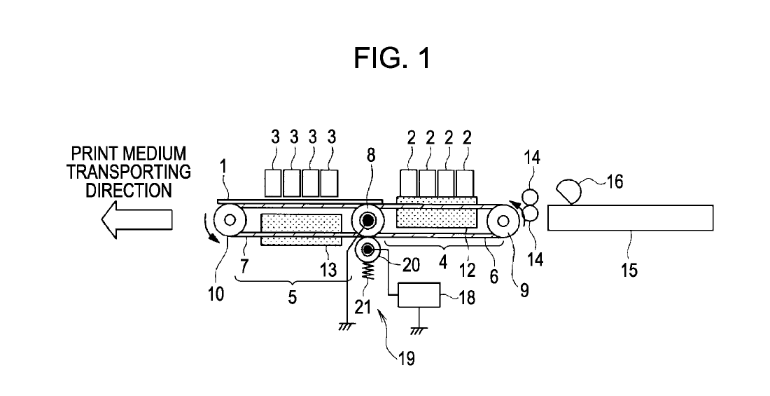

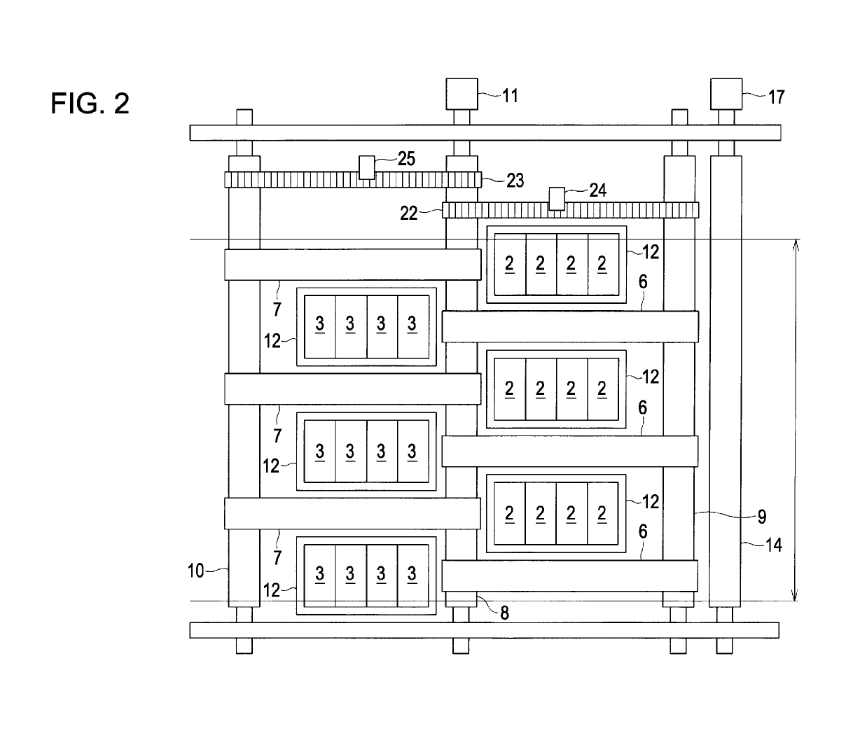

Next, an ink jet printer according to a first embodiment of the invention will be described with reference to the accompanying drawings. FIGS. 1 and 2 are schematic views showing the configuration of the ink jet printer according to the invention. FIG. 1 is a front view of the ink jet printer according to the present embodiment and FIG. 2 is a plan view thereof. FIG. 1 shows a line head ink jet printer in which a print medium 1 is transported from a right side to a left side of the drawing in a direction denoted by an arrow of the drawing and printing is performed in a print region while the print medium is transported. In the present embodiment, ink jet heads are arranged at two places, not one place.

In the drawing, a reference numeral 2 is a first ink jet head provided at an upstream side of a transporting direction of the print medium 1, a reference numeral 3 is a second ink jet head provided at a downstream side of the transporting direction of the print medium, a first transporting unit 4 for transporting the print medium 1 is provided below the first ink jet heads 2, and a second transporting unit 5 is provided below the second ink jet heads 3. The first transporting unit 4 is composed of three first transporting belts 6 arranged at a predetermined interval in a direction (hereinafter, also referred to as a nozzle row direction) crossing the transporting direction of the print medium 1 and the second transporting unit 5 is composed of three second transporting belts 7 arranged at a predetermined interval in the direction (the nozzle row direction) crossing the transporting direction of the print medium 1.

Similar to the three first transporting belts 6, the three second transporting belts 7 are arranged to be alternately adjacent in a zigzag manner. A driving roller 8 is provided in an overlapped portion of the first transporting belt 6 and the second transporting belt 7, a first driven roller 9 is provided at the upstream side thereof, a second driving roller 10 is provided at the downstream side thereof, the first transporting belt 6 is wound around the driving roller 8 and the first driven roller 9, the second transporting belt 7 is wound around the driving roller 8 and the second driven roller 10, and an electric motor 11 is connected to the driving roller 8. Accordingly, when the driving roller 8 is rotated by the electric motor 11, the first transporting unit 4 composed of the three first transporting belts 6 and the second transporting unit 5 composed of the three second transporting belts 7 are moved at the same speed in synchronization with each other.

The first ink jet heads 2 and the second ink jet heads 3 are arranged to be shifted in the transporting direction of the print medium 1, for example, for each of the four colors of yellow (Y), magenta (M), cyan (C) and black (K). The inks are supplied from ink tanks of the respective colors (not shown) to the ink jet heads 2 and 3 through ink supply tubes. In the ink jet heads 2 and 3, a plurality of nozzles are formed in the direction (that is, the nozzle row direction) crossing the transporting direction of the print medium 1. The nozzles simultaneously discharge a predetermined amount of ink droplets at required places so as to form and output minute ink dots on the print medium 1. If this operation is performed for each color, the so-called one-pass printing can be performed by passing the print medium 1 transported by the first transporting unit 4 and the second transporting unit 5 once. That is, the region in which the ink jet heads 2 and 3 are arranged corresponds to a print region.

Examples of a method of discharging the inks from the nozzles of the ink jet heads include an electrostatic method, a piezoelectric method, and a film boiling ink jet method. In the electrostatic method, if a driving signal is applied to an electrostatic gap which is an actuator, a vibration plate in a cavity is displaced such that a variation in pressure is generated in the cavity, and ink droplets are discharged from the nozzles by the variation in pressure. In the piezoelectric method, if a driving signal is applied to a piezoelectric element which is an actuator, a vibration plate in a cavity is displaced such that a variation in pressure is generated in the cavity, and ink droplets are discharged from the nozzles by the variation in pressure. In the film boiling ink jet method, a minute heater is included in a cavity and is instantaneously heated to 300° C. or more such that the ink becomes a film boiling state to generate bubbles, and ink droplets are discharged from the nozzles by a variation in pressure. The invention is applicable to any ink outputting method, but is particularly suitable for a piezoelectric element which can adjust the crest value of the driving signal or a voltage increase/decrease slope so as to adjust the discharge amount of ink droplets. The piezoelectric element is a so-called charging/discharging actuator having capacitance.

The first ink jet heads 2 are arranged among the three first transporting belts 6 of the first transporting unit 4 and above the first transporting belt 6 of an uppermost stage of the nozzle row direction of FIG. 2. The second ink jet heads 3 are arranged among the three second transporting belts 7 of the second transporting unit 5 and below the first transporting belt 7 of a downmost stage of the nozzle row direction of FIG. 2. This configuration allows a cleaning unit to the ink jet heads 2 and 3. However, in this configuration, one-pass full-page printing cannot be performed by only one ink jet head. Accordingly, in order to compensate for portions which cannot be printed, the first ink jet heads 2 and the second ink jet heads 3 are arranged to be shifted in the transporting direction of the print medium 1.

A first cleaning cap 12 for cleaning the first ink jet heads 2 is provided below the first ink jet heads 2 and a second cleaning cap 13 for cleaning the second ink jet heads 3 is provided below the second ink jet heads 3. Both the cleaning caps 12 and 13 are formed in a size which can pass among the three first transporting belts 6 of the first transporting unit 4 and among the three second transporting belts 7 of the second transporting unit 5. Each of the cleaning caps 12 and 13 includes, for example, cap body which covers the nozzles formed in the lower surfaces, that is, the nozzle surfaces, of the ink jet heads 2 or 3 and has a rectangular bottom closely adhered to the nozzle surfaces, an ink absorber provided at the bottom thereof, a tube pump connected to the bottom of the cap body, and an elevator for ascending/descending the cap body. The cap body is ascended by the elevator to be closely adhered to the nozzle surfaces of the ink jet heads 2 or 3. In this state, if the inside of the cap body is put under negative pressure, the ink droplets or bubbles are sucked from the nozzles formed in the nozzle surfaces of the ink jet heads 2 and 3 such that the ink jet heads 2 and 3 can be cleaned. If the cleaning is finished, the cleaning caps 12 and 13 are descended.

A pair of gate rollers 14 for adjusting a feeding timing of the print medium 1 fed from a feeding unit 15 and correcting the skew of the print medium 1 is provided at the upstream side of the first driven roller 9. The skew is the twist of the print medium 1 with respect to the transporting direction. A pickup roller 16 for supplying the print medium 1 is provided above the feeding unit 15. In the drawing, a reference numeral 17 is a gate roller motor for driving the gate rollers 14.

A belt charging device 19 is provided below the driving roller 8. The belt charging device 19 includes a charging roller 20 which is in contact with the first transporting belt 6 and the second transporting belt 7 with the driving roller 8 interposed therebetween, a spring 21 for pressing the charging roller 20 toward the first transporting belt 6 and the second transporting belt 7, and a power supply 18 for applying charges to the charging roller 20. The charges are applied from the charging roller 20 to the first transporting belt 6 and the second transporting belt 7 so as to charge the belts. In general, the belts are made of a medium/high resistor or an insulator. Accordingly, if the belt is charged by the belt charging device 19, dielectric polarization is caused in the print medium 1 made of an insulator, and the print medium 1 can be adsorbed to the belt by electrostatic force generated between the charges generated by the dielectric polarization and the charges of the surface of the belt. An example of the belt charging device 19 may be so-called corotron for descending the charges.

Therefore, according to this ink jet printer, when the surfaces of the first transporting belt 6 and the second transporting belt 7 are charged by the belt charging device 19, the print medium 1 is fed from the gate rollers 14 in this state, and the print medium 1 is pressed to the first transporting belt 6 by a paper pressing roller composed of a spur or a roller (not shown), the print medium 1 is adsorbed to the surface of the first transporting belt 6 by the above-described dielectric polarization. In this state, when the driving roller 8 is rotated by the electric motor 11, the rotation force thereof is delivered to the first driven roller 9 through the first transporting belt 6.

The first transporting belt 6 to which the print medium 1 is adsorbed is moved to the downstream side of the transporting direction, the print medium 1 is moved below the first ink jet heads 2, and the ink droplets are discharged from the nozzles formed in the first ink jet heads 2, thereby performing the printing. If the printing using the first ink jet heads 2 is finished, the print medium 1 is moved to the downstream side of the transporting direction and is transferred to the second transporting belt 7. As described above, since the surface of the second transporting belt 7 is also charged by the belt charging device 19, the print medium 1 is adsorbed to the surface of the second transporting belt 7 by the dielectric polarization.

In this state, the second transporting belt 7 is moved to the downstream side of the transporting direction, the print medium 1 is moved below the second ink jet heads 3, and the ink droplets are discharged from the nozzles formed in the second ink jet heads, thereby performing the printing. If the printing using the second ink jet heads is finished, the print medium 1 is further moved to the downstream side of the transporting direction and the print medium 1 is separated from the surface of the second transporting belt 7 by a separation device (not shown) and is ejected to an ejection unit.

If the cleaning of the first and second ink jet heads 2 and 3 is required, as described above, the first and second cleaning caps 12 and 13 are ascended to be closely adhered to the nozzle surfaces of the first and second ink jet heads 2 and 3. In this state, the inside of the cap body is put under negative pressure such that the ink droplets or the bubbles are sucked from the nozzles of the first and second ink jet heads 2 and 3, thereby performing the cleaning. Thereafter, the first and second cleaning caps 12 and 13 are descended.

A first linear scale 22 which rotates in synchronization with the first transporting belt 6 is wound around the driving roller 8 and the first driven roller 9, a second linear scale 23 which rotates in synchronization with the second transporting belt 7 is wound around the driving roller 8 and the second driven roller 10, the movement state of the first linear scale 22 is detected by a first encoder sensor 24, and the movement state of the second linear scale 23 is detected by a second encoder sensor 25. In the present embodiment, as described above, the print medium 1 is transported in a state of being electrostatically adsorbed to the first transporting belt 6 and the second transporting belt 7. Accordingly, for example, if the movement state of the first linear scale 22 which rotates in synchronization with the first transporting belt 6 is detected by the first encoder sensor 24, the transporting state of the print medium 1 which is transported in the state of being electrostatically adsorbed to the first transporting belt 6 can be detected and, if the movement state of the second linear scale 23 which rotates in synchronization with the second transporting belt 7 is detected by the second encoder sensor 25, the transporting state of the print medium 1 which is transported in the state of being electrostatically adsorbed to the second transporting belt 7 can be detected. Accordingly, when the nozzle actuators of the ink jet heads 2 and 3 are driven so as to discharge the ink droplets according to an output signal of the first encoder sensor 24 or an output signal (encoder pulse) of the second encoder signal 25, it is possible to form ink dots at predetermined positions of the print medium 1.

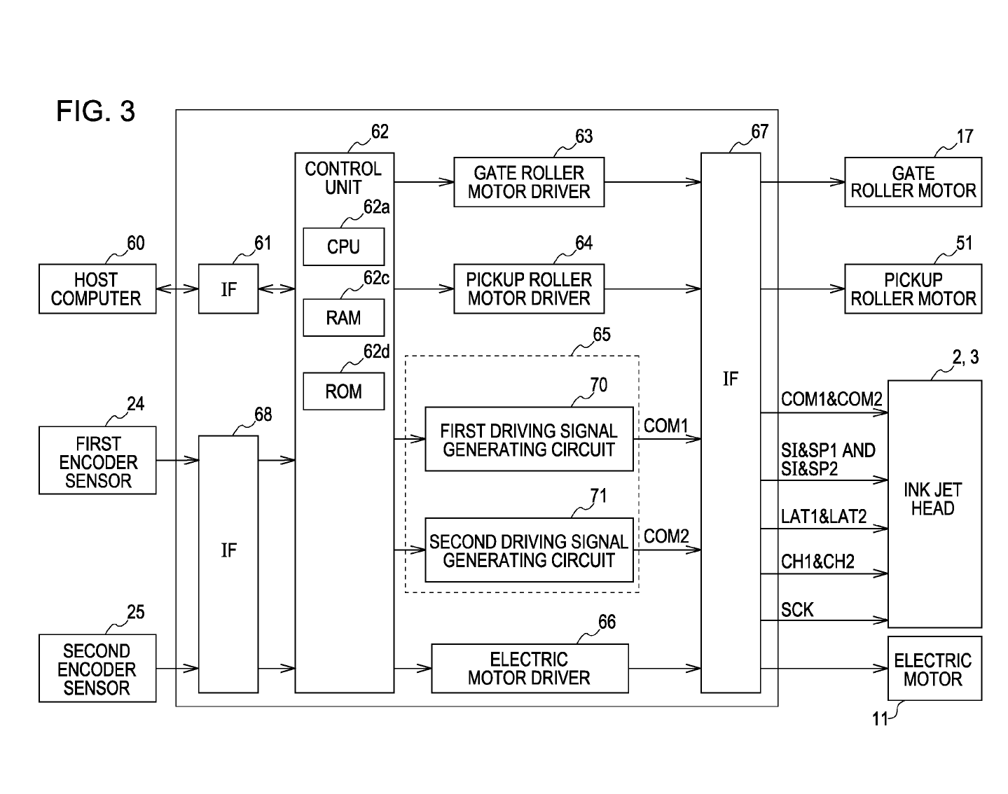

In the ink jet printer, a control device for the ink jet printer is provided. This control device controls a printing device or a feeding device so as to perform a printing process with respect to the print medium, on the basis of, for example, print data input from a host computer 60 such as a personal computer or a digital camera, as shown in FIG. 3. The control device includes an input interface 61 which receives the print data from the host computer 60, an input interface 68 which receives the output signals of the first encoder sensor 24 and the second encoder sensor 25, a control unit 62 composed of, for example, a microcomputer for performing the printing process on the basis of the input signal or the print data received from the input interfaces 61 and 68, a gate roller motor driver 63 for controlling the driving of the gate roller motor 17, a pickup roller motor driver 64 for controlling the driving of a pickup roller motor 51 for driving the pickup roller 16, a head driver 65 for controlling the driving of the ink jet heads 2 and 3, an electric motor driver 66 for controlling the driving of the electric motor 11, and an interface 67 for converting the output signals of the drivers 63 to 66 into the driving signals which are used by the external gate roller motor 17, the pickup roller motor 51, the ink jet heads 2 and 3, and the electric motor 11.

The control unit 62 includes a central processing unit 62a for performing various types of processes such as the printing process, a random access memory (RAM) 62c for temporarily storing the print data input through the input interface 61 or a variety of data at the time of performing the print data printing process or temporarily developing an application program such as the printing process, and a read-only memory (ROM) 62d composed of a non-volatile semiconductor memory for storing a control program executed by the CPU 62a. When the control unit 62 receives the print data (image data) from the host computer 60 through the interface 61, the CPU 62a performs a predetermined process with respect to the print data, outputs print data (driving signal selection data SI&SP) indicating from which of the nozzles the ink droplets are discharged or how much the ink droplets are discharged, and outputs control signals to the drivers 63 to 66 on the basis of the print data and the input data from the various sensors. The driving signals for driving the respective actuators are output from the drivers 63 to 66 and are converted into adequate signal forms by the interface 67. The actuators corresponding to the plurality of nozzles of the ink jet heads, the gate roller motor 17, the pickup roller motor 51 and the electric motor 11 are operated such that the feeding and the transporting of the print medium 1, the attitude control of the print medium 1, and the printing process of the print medium 1 are performed. The components of the control unit 62 are electrically connected through buses (not shown).

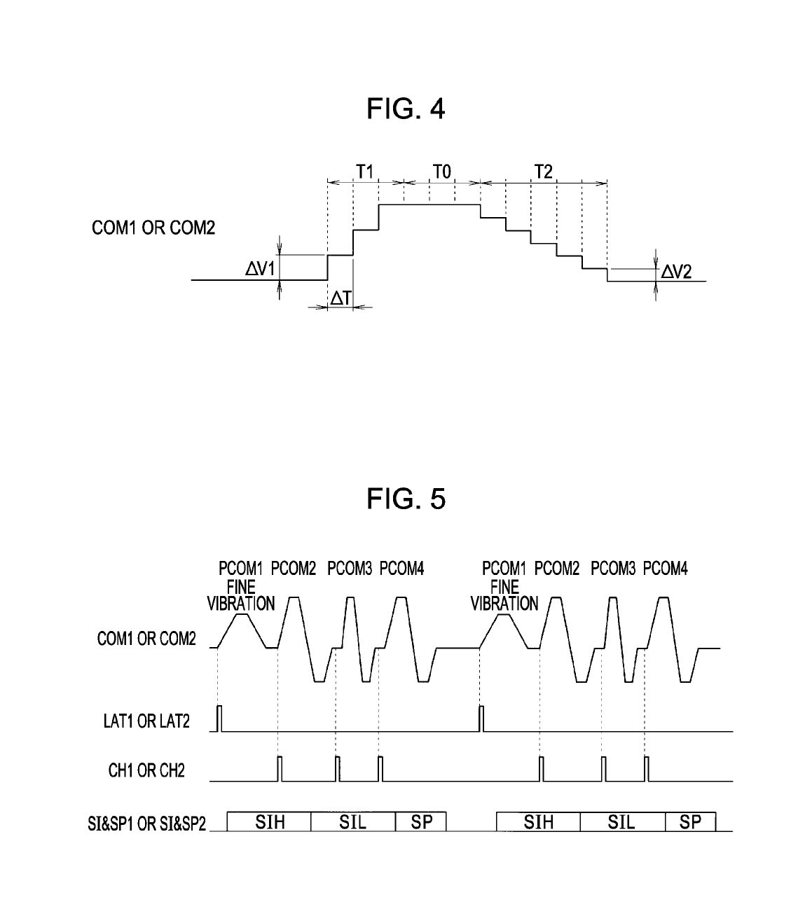

The head driver 65 includes a first driving signal generating circuit 70 for outputting a first driving signal COM1 on the basis of the output signal of the first encoder sensor 24 and a second driving signal generating circuit 71 for outputting a second driving signal COM2 on the basis of the output signal of the second encoder sensor 25. For example, as shown in FIG. 4, these driving signal generating circuits 70 and 71 increase the first driving signal COM1 or the second driving signal COM2 by waveform data +ΔV1 at a rising timing of a clock signal during a time width T1 from a state in which the first driving signal COM1 or the second driving signal COM2 rises to a medium potential (offset) maintain the first driving signal COM1 or the second driving signal COM2 at a constant value during a time width T0, and decrease the first driving signal COM1 or the second driving signal COM2 by waveform data −ΔV2 at a rising timing of the clock signal during a time width T2. The first driving signal COM1 or the second driving signal COM2 generated by the above-described operation is converted into an analog signal by, for example, the interface 67, is power amplified and is supplied to the ink jet heads 2 and 3 such that the actuators such as the piezoelectric elements provided at the nozzles can be driven and the ink droplets can be discharged from the nozzles.

A rising portion of the first driving signal COM1 or the second driving signal COM2 is a stage in which the ink is drawn in by increasing the volume of the cavity (pressure chamber) communicated with the nozzles (meniscus is drawn in when taking into consideration the discharge surface of the ink) and a falling portion of the first driving signal COM1 or the second driving signal COM2 is a stage in which the ink is pushed out by decreasing the volume of the cavity (meniscus is pushed out when taking into consideration the discharge surface of the ink). When the ink is pushed out, the ink droplets are discharged from the nozzles. In addition, the waveform of the first driving signal COM1 or the second driving signal COM2 can be adjusted by the waveform data 0, +ΔV1, −ΔV2, +ΔV3 and the clock signal for generating the first driving signal COM1 or the second driving signal COM2, as can be readily supposed by the above description. Since the piezoelectric element is a capacitive load and the so-called charging/discharging actuator, for example, in the present embodiment, charges are charged in the charging/discharging actuator at the rising portion of the driving signal COM and are discharged in the charging/discharging actuator at the falling portion of the driving signal COM.

By variously changing the voltage increase/decrease slope or the crest value of the first driving signal COM1 or the second driving signal COM2 having a trapezoidal wave voltage, the draw-in amount or draw-in speed of ink or the push-out amount or push-out speed of ink can be changed. Thus, the discharge amount of the ink droplets can be changed such that the size of the ink dot can be changed. Accordingly, for example, as shown in FIG. 5, a plurality of driving pulses PCOM are connected in time series to generate the first driving signal COM1 or the second driving signal COM2, a single driving pulse PCOM is selected from them to be supplied to the nozzle actuators such as the piezoelectric elements, the ink droplets are discharged or the plurality of driving pulses PCOM is selected to be supplied to the nozzle actuators such as the piezoelectric elements, and the ink droplets are discharged several times, thereby obtaining the ink dots having various sizes. That is, if a plurality of ink droplets are hit at the same position while the ink is not dried, substantially large ink droplets are discharged and thus the size of the ink dots can be increased. It is possible to achieve multi-gradation by a combination of such technologies. The ink is drawn in but is not pushed out by the driving pulse PCOM1 of the left end of FIG. 5. This is called fine vibration and is, for example, used to suppress or prevent the nozzles from being dried, without discharging the ink droplets.

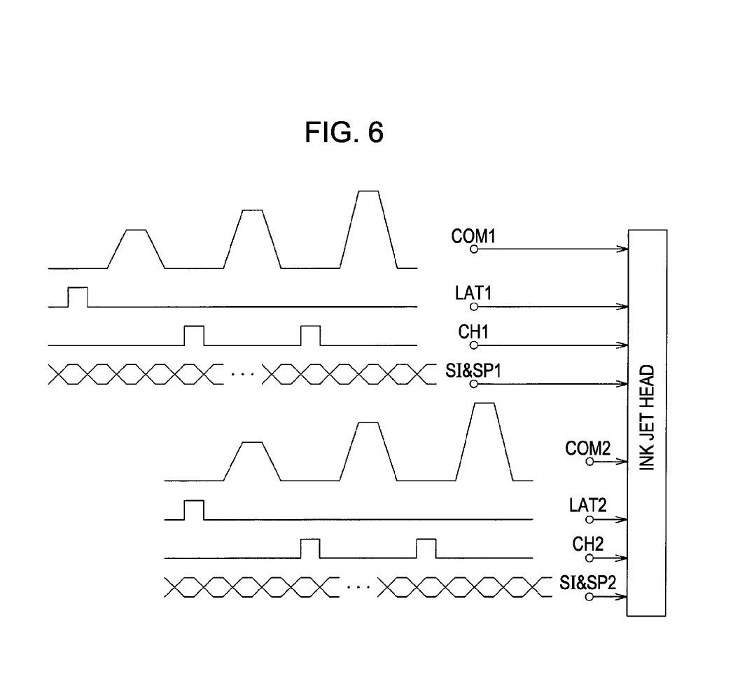

As a result, as shown in FIG. 6, the first driving signal COM1 generated by the first driving signal generating circuit 70, the second driving signal COM2 generated by the second driving signal generating circuit 71, a first driving signal selection data signal SI&SP1 for selecting the discharge nozzle on the basis of the print data and supplying the first driving signal COM1 to the nozzle actuator such as the piezoelectric elements, a second driving signal selection data signal SI&SP2 for selecting the discharge nozzle on the basis of the print data and supplying the second driving signal COM2 to the nozzle actuators such as the piezoelectric element, after the nozzle selection data is input to all the nozzles, a first latch signal LAT1 and a first channel signal CH1 for connecting the first driving signal COM1 with the nozzle actuators of the ink jet heads 2 and 3 on the basis of the first driving signal selection data SI&SP1, a second latch signal LAT2 and a second channel signal CH2 for connecting the second driving signal COM2 with the nozzle actuators of the ink jet heads 2 and 3 on the basis of the second driving signal selection data SI&SP2, and a clock signal SCK for transmitting the first driving signal selection data signal SI&SP1 and the second driving signal selection data SI&SP2 to the ink jet heads 2 and 3 as a serial signal are input to the ink jet heads 2 and 3. All the first driving signal COM1, the first latch signal LAT1, the first channel signal CH1 are output in synchronization with the output signal (encoder pulse) of the first encoder sensor 24 and all the second driving signal COM2, the second latch signal LAT2, the second channel signal CH2 are output in synchronization with the output signal (encoder pulse) of the second encoder sensor 25.

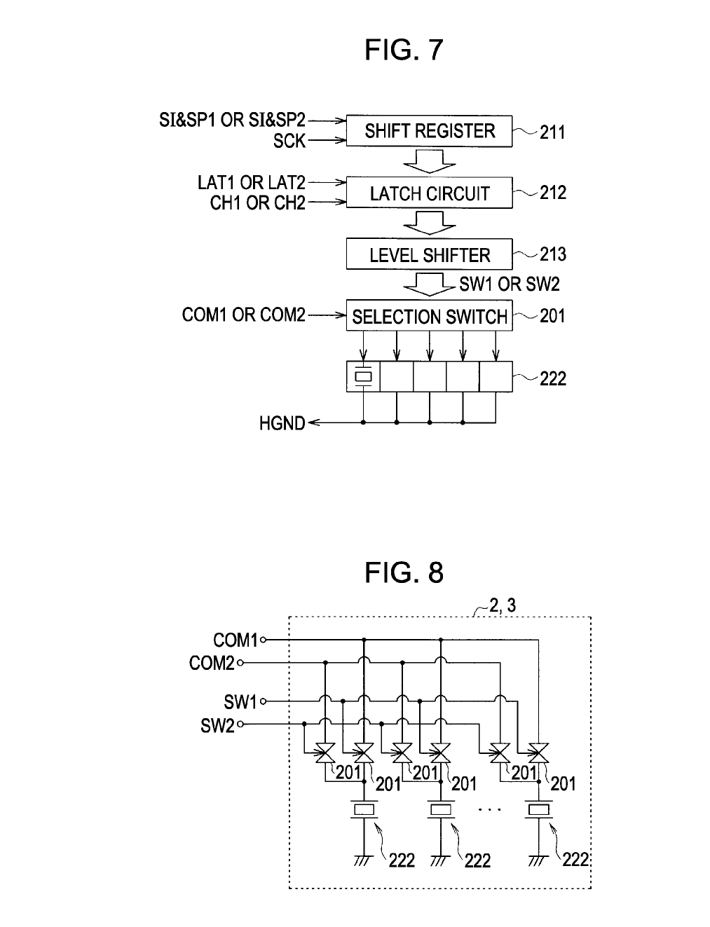

Next, the configuration for connecting the first driving signal COM1 output from the first driving signal generating circuit 70 or the second driving signal COM2 output from the second driving signal generating circuit 71 with the nozzle actuators such as the piezoelectric element will be described. FIG. 7 is a block diagram of a selection unit which is provided in each of the ink jet heads 2 and 3 in order to connect the first driving signal COM1 or the second driving signal COM2 to the nozzle actuators 222 such as the piezoelectric elements. In the ink jet heads 2 and 3, two selection units are provided in the nozzle row of each color. Each selection unit includes a shift register 211 which holds the first driving signal selection data SI&SP1 or the second driving signal selection SI&SP2 for specifying the nozzle actuators 222 such as the piezoelectric elements corresponding to the nozzles for discharging the ink droplets, a latch circuit 212 which temporarily holds the data of the shift register 211 according to the first latch signal LAT1 or the second latch signal LAT2 and the first channel signal CH1 or the second channel signal CH2, a level shifter 213 which shifts the level of the output of the latch circuit 212 and outputs a first switch signal SW1 for connecting the first driving signal COM1 or a second switch signal SW2 for connecting the second driving signal COM2, and selection switches 201 which connect the first driving signal COM1 or the second driving signal COM2 to the nozzle actuators 222 such as the piezoelectric elements according to the output of the level shifter.

The first driving signal selection data SI&SP1 or the second driving signal selection data SI&SP2 is sequentially input to the shift register 211 and a storage region is sequentially shifted from a first stage to a next stage according to the input pulse of the clock signal SCK. The latch circuit 212 latches the output signals of the shift register 211 by the input first latch signal LAT1 or the second latch signal LAT2 and the first channel signal CH1 or the second channel signal CH2, after the first driving signal selection data SI&SP1 or the second driving signal selection data SI&SP2 are stored in the shift register 11 by the number of nozzles. The signal held by the latch circuit 212 is converted into a voltage level for turning on/off a next-stage selection switch 201 by the level shifter 213. This is because the first driving signal COM1 or the second driving signal COM2 is higher than the output voltage of the latch circuit 212 and thus an operation voltage range of the selection switch 201 is set to be high. Accordingly, the nozzle actuators such as the piezoelectric elements corresponding to the selection switches 201 closed by the level shifter 213 are connected to the first driving signal COM1 or the second driving signal COM2 at a connection timing of the first driving signal selection data SI&SP1 or the second driving signal selection data SI&SP2. In addition, after the first driving signal selection data SI&SP1 or the second driving signal selection data SI&SP2 of the shift register 211 is held by the latch circuit 212, next print information is input to the shift register 211, and the held data of the latch circuit 212 is sequentially updated in accordance with a discharge timing of the ink droplets. In the drawing, a reference letter HGND is ground of the nozzle actuators 222 such as the piezoelectric elements. According to the selection switches 201, even after the nozzle actuators such as the piezoelectric elements are disconnected from the first driving signal COM1 or the second driving signal COM2, the input voltages of the actuators 222 are held at the voltage immediately before the disconnection.

FIG. 8 is a block diagram showing a relationship between the nozzle actuators 222 and the selection switches 201 of the ink jet heads 2 and 3 and the first driving signal COM1, the second driving signal COM2, the first switch signal SW1, and the second switch signal SW2. As can be seen from FIG. 8, in the present embodiment, the first driving signal COM1 and the second driving signal COM2 are connected to each of all the nozzle actuators 222 through two selection switches 201. When one of the selection switches 201 is switched on by the first switch signal SW1, the first driving signal COM1 is supplied to the nozzle actuators 222 and, when the other of the selection switches 201 is switched on by the second switch signal SW2, the second driving signal COM2 is supplied to the nozzle actuators 222.

In the present embodiment, when the print medium 1 is transferred from the first transporting unit 4 composed of the first transporting belt 6 to the second transporting unit 5 composed of the second transporting belt 7, for example, at a time point when a half the transporting-direction length of the print medium 1 is mounted on the second transporting unit 5, the output signal (encoder pulse) of the first encoder sensor 24 and the output signal (encoder signal) of the second encoder sensor 25 for controlling the discharge timing of the ink droplets are switched. That is, the first driving signal COM1 which is synchronized with the output signal (encoder pulse) of the first encoder sensor 24 and the second driving signal COM2 which is synchronized with the output signal (encoder pulse) of the second encoder sensor 25 are switched. However, in the present embodiment, the driving signals of the nozzle actuators of all the nozzle rows are not simultaneously switched from the first driving signal COM1 to the second driving signal COM2, and a region in which the first driving signal COM1 and the second driving signal COM2 are mixed is formed.

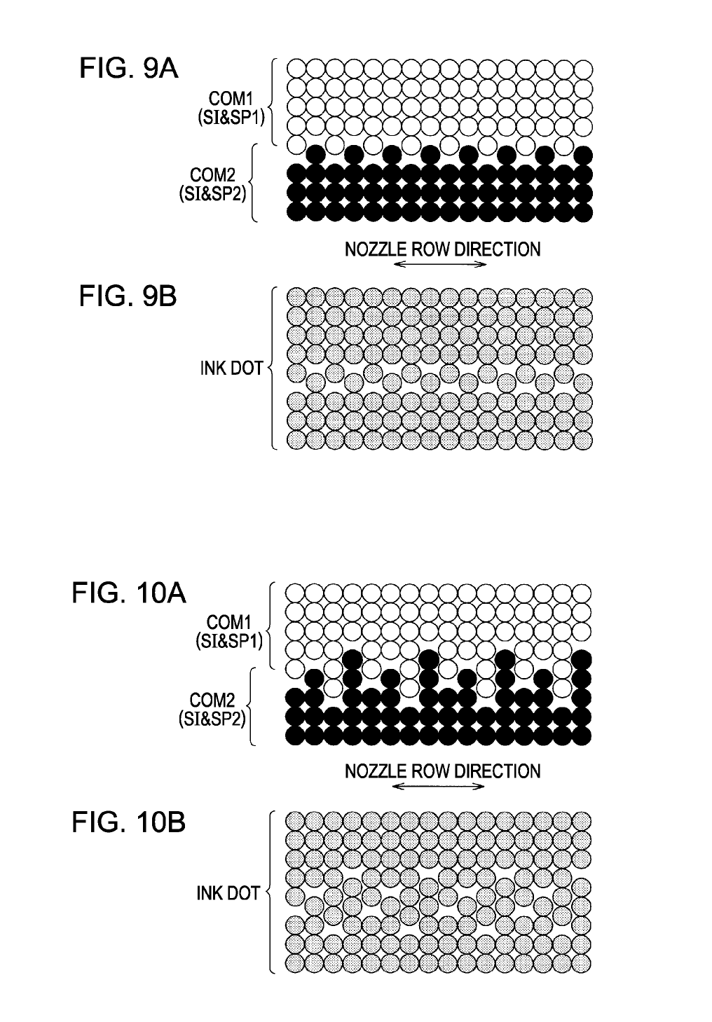

For example, FIG. 9 shows an example of the switching of the first driving signal COM1 and the second driving signal COM2 and FIG. 10 is another example thereof. FIGS. 9A and 10A show the selection states of the first driving signal COM1 and the second driving signal COM2 for each nozzle and FIGS. 9B and 10B show the ink dot states by the selected first driving signal COM1 or second driving signal COM2. In FIG. 9, the first driving signal COM1 and the second driving signal COM2 are alternately mixed in one nozzle row. In FIG. 10, the first driving signal COM1 and the second driving signal COM2 are mixed in three nozzle rows. As described above, since the first driving signal COM1 is selected by the first driving signal selection data SI&SP1 and the second driving signal COM2 is selected by the second driving signal selection data SI&SP2, in a case where the first driving signal COM1 according to the output signal (encoder pulse) of the first encoder sensor 24 and the second driving signal COM2 according to the output signal (encoder pulse) of the second encoder sensor 25 are mixed in the nozzle row, the first driving signal selection data SI&SP1 and the second driving signal selection data SI&SP2 are appropriately set.

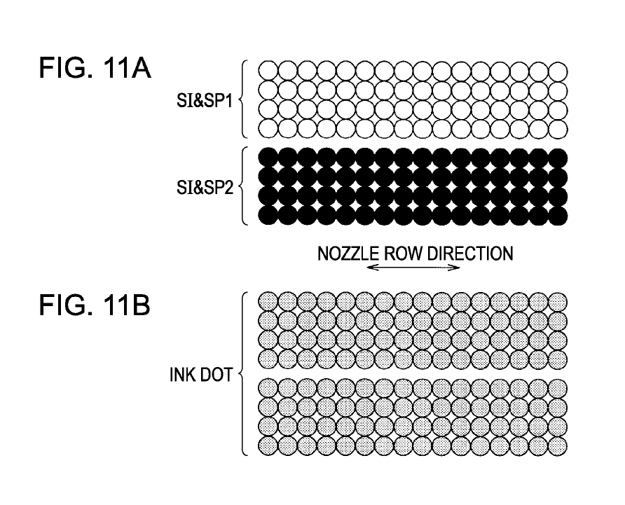

For example, FIG. 11 shows a case where the driving signals of the nozzle actuators of all the nozzle rows are simultaneously switched from the first driving signal COM1 to the second driving signal COM2. In this case, for example, if the phases of the output signal (encoder pulse) of the first encoder sensor 24 and the output signal (encoder pulse) of the second encoder sensor 25 are shifted, as shown in FIG. 11, image shift having a stripe shape occurs in the change portion of the output signal (encoder pulse) of the encoder sensor and thus image quality deteriorates. However, as the present embodiment, if the first driving signal COM1 according to the output signal (encoder pulse) of the first encoder sensor 24 and the second driving signal COM2 according to the output signal (encoder pulse) of the second encoder sensor 25 are mixed in the same nozzle row, the image shift is made inconspicuous and thus excellent image quality can be ensured. In addition, as the present embodiment, when the first driving signal COM1 and the second driving signal COM2 are separately generated, the ink dots according to the first driving signal COM1 and the ink dots according to the second driving signal COM2 may overlap each other. However, since the switching to the second driving signal COM2 is not made while the first driving signal COM1 is input, the overlapping occurs only when the pulse period of the output signal of the first encoder sensor 24 is not sufficiently larger than the signal period of the first driving signal COM1 and thus is unlikely to occur.

In the ink jet printer according to the present embodiment in which the ink jet heads 2 and 3 are arranged in correspondence with the print region and the printing is performed with respect to the print region while the print medium 1 is transported, the transporting state of the print medium 1 by the first transporting unit 4 (first print medium transporting unit) provided at the upstream side of the print medium transporting direction is detected by the first encoder sensor 24 (first print medium transporting state detecting device), the transporting state of the print medium 1 by the second transporting unit 5 (second print medium transporting unit) provided at the downstream side of the print medium transporting direction of the first transporting unit 4 is detected by the second encoder sensor 25 (second print medium transporting state detecting device) the first driving signal COM1 to the nozzle actuators 222 is generated according to the transporting state of the print medium 1 by the first transporting unit 4 detected by the first encoder sensor 24, the second driving signal COM2 to the nozzle actuators 222 is generated according to the transporting state of the print medium 1 by the second transporting unit 5 detected by the second encoder sensor 25, and the first driving signal COM1 generated by the first driving signal generating circuit 70 (first driving signal generating device) and the second driving signal COM2 generated by the second driving signal generating circuit 71 (second driving signal generating device) are mixed and output to the plurality of nozzles arranged in the ink jet heads 2 and 3 in the direction crossing the print medium transporting direction. Accordingly, when the print medium 1 is transferred from the first transporting unit 4 at the upstream side of the print medium transporting direction to the second transporting unit 5 at the downstream side of the print medium transporting direction, print image shift can be made inconspicuous and thus excellent print image quality can be ensured.

Even when the first driving signal COM1 and the second driving signal COM2 are switched in accordance with the transferring of the print medium 1 from the first transporting unit 4 to the second transporting unit 5, the first driving signal COM1 and the second driving signal COM2 are mixed and output to the plurality of nozzles arranged in the ink jet heads 2 and 3 in the direction crossing the transporting direction of the print medium 1. Accordingly, print image shift can be made inconspicuous with certainty and thus more excellent print image quality can be ensured.

Since the first transporting unit 4 and the second transporting unit 5 are respectively composed of the first transporting belt 6 and the second transporting belt 7 and the first print medium transporting state detecting device and the second print medium transporting state detecting device are respectively composed of the first encoder sensor 24 and the second encoder sensor 25 for detecting the transporting state of the print medium from the movement states of the first transporting belt 6 and the second transporting belt 7, the configuration becomes simplified and the invention is easy to be implemented.

What is claimed is:

1. An ink jet printer in which ink jet heads are arranged in correspondence with a print region and printing is performed with respect to the print region while transporting a print medium, the ink jet printer comprising:
a first print medium transporting unit provided at an upstream side of a print medium transporting direction;
a second print medium transporting unit provided at a downstream side of the print medium transporting direction of the first print medium transporting unit so as to continuously transport the print medium from the first print medium transporting unit;
a first print medium transporting state detecting device which detects a transporting state of the print medium by the first print medium transporting unit;
a second print medium transporting state detecting device which detects the transporting state of the print medium by the second print medium transporting unit;
a plurality of nozzles arranged in the ink jet heads in a direction crossing the print medium transporting direction;
actuators provided in correspondence with the nozzles;
a first driving signal generating device which generates a first driving signal to the actuators according to the transporting state of the print medium by the first print medium transporting unit detected by the first print medium transporting state detecting device;
a second driving signal generating device which generates a second driving signal to the actuators according to the transporting state of the print medium by the second print medium transporting unit detected by the second print medium transporting state detecting device; and
a control device which mixes and outputs the first driving signal generated by the first driving signal generating device and the second driving signal generated by the second driving signal generating device to the plurality of nozzles arranged in the ink jet heads in the direction crossing the print medium transporting direction.

2. The ink jet printer according to claim 1, wherein the control device mixes and outputs the first driving signal and the second driving signal to the plurality of nozzles arranged in the ink jet heads in the direction crossing the print medium transporting direction, even when the first driving signal and the second driving signal are switched in accordance with the transferring of the print medium from the first print medium transporting unit to the second print medium transporting unit.

3. The ink jet printer according to claim 1, wherein the first print medium transporting unit and the second print medium transporting unit are respectively composed of a first transporting belt and a second transporting belt, and the first print medium transporting state detecting device and the second print medium transporting state detecting device are respectively composed of first and second encoder sensors which detect the transporting states of the print medium from movement states of the first transporting belt and the second transporting belt.
